(19) United States
(12) Patent Application Publication
(10) Pub. No.: US 2026/0170223 A1
(43) Pub. Date: Jun. 18, 2026

(54) METHOD OF AND SYSTEM FOR GENERATING LAYOUT DIAGRAM OF INTEGRATED CIRCUIT DEVICE HAVING TRANSISTOR ARCHITECTURE

(71) Applicant: TAIWAN SEMICONDUCTOR MANUFACTURING COMPANY, LTD., Hsinchu (TW)

(72) Inventors: Hsiu-Chuang CHANG, Hsinchu (TW); Hsiang-Ho CHANG, Hsinchu (TW)

(21) Appl. No.: 19/172,865

(22) Filed: Apr. 8, 2025

Related U.S. Application Data
(60) Provisional application No. 63/733,833, filed on Dec. 13, 2024.

(51) Int. Cl. G06F 30/398; G06F 119/16

(52) U.S. Cl. CPC G06F 30/398; G06F 2119/16

(57) ABSTRACT

A method of generating a layout diagram (of an integrated circuit (IC) device) includes: receiving the layout diagram of the IC device, the IC layout diagram including a gate region having a first width across an active region and a first gate via at a first location along the first width; building a gate-resistance compact network which includes at least four nodes of a three-dimensional transistor architecture represented by the layout diagram and at least five equivalent resistances between corresponding ones of the at least four nodes; determining an effective resistance of the gate region based on the equivalent resistances; and determining compliance of the effective resistance with a design specification.

### CROSS-REFERENCE TO RELATED APPLICATION(S)

This application claims the benefit of U.S. Provisional Application No. 63/733,833, filed Dec. 13, 2024, the entire disclosure of which is incorporated by reference herein.

### BACKGROUND

The prevailing trend in the miniaturization of integrated circuits (ICs) has led to the development of increasingly compact devices that consume less power while delivering enhanced functionality at higher speeds compared to previous technologies. This miniaturization has been realized through advancements in design and manufacturing, which adhere to increasingly stringent specifications. A variety of electronic design automation (EDA) tools are employed to create, modify, and validate designs for semiconductor devices, ensuring compliance with both design and manufacturing specifications.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a flowchart of a method of manufacturing an IC device in accordance with some embodiments of the present disclosure.

FIG. 2A is a layout diagram of an IC device illustrating a plurality of locations on a gate region in accordance with some embodiments of the present disclosure.

FIG. 2B is a layout diagram of an IC device illustrating gate vias disposed on the gate region in the layout diagram in accordance with the embodiment of FIG. 2A.

FIGS. 3A and 3B are diagrams of a semiconductor structure of a finFET in accordance with some embodiments of the present disclosure.

FIGS. 4A and 4B are diagrams of a semiconductor structure of a nanosheet FET in accordance with some embodiments of the present disclosure.

FIG. 5A is a diagram illustrating four nodes within a three-dimensional transistor architecture in accordance with some embodiments of the present disclosure.

FIG. 5B is a diagram illustrating a 5-resistor diamond gate-resistance network in accordance with some embodiments of the present disclosure.

FIGS. 6A to 6F illustrate different networks equivalent to the 5-resistor diamond gate-resistance network using the delta-star transformation technique, in accordance with some embodiments of the present disclosure.

FIGS. 7A to 7D illustrate simplification of different networks, in accordance with some embodiments of the present disclosure.

FIGS. 8A to 8C are layout diagrams illustrating a gate region extending across two transistor devices with different locations of gate vias disposed thereon, in accordance with some embodiments of the present disclosure.

FIGS. 9A to 9F are layout diagrams of various arrangements of gate vias in accordance with different embodiments of the present disclosure.

FIGS. 10A to 10F are cross sections corresponding to the layout diagrams in FIGS. 9A to 9F.

FIGS. 11A to 11H are layout diagrams illustrating different arrangements of gate via(s) in accordance with some embodiments of the present disclosure.

FIG. 12 is a block diagram of IC device design system 1200, in accordance with some embodiments of the present disclosure.

FIG. 13 is a block diagram of IC manufacturing system 1300, and an IC manufacturing flow associated therewith, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

In some embodiments, an effective gate resistance of an IC device is modeled using a gate-resistance compact network that includes at least four nodes of a three-dimensional transistor architecture represented by a layout diagram and at least five equivalent resistances between corresponding ones of the at least four nodes. The gate-resistance compact network of at least some embodiments is based on one or more gate via locations along the gate width in the layout diagram of the IC device. Another approach for determining effective gate resistance uses at least four nodes but fewer than at least five equivalent resistances between corresponding ones of the at least four nodes. The gate-resistance compact network of at least some embodiments more accurately estimates gate resistance values as compared to the other approach.

In various embodiments, the symbols A, B, C, and G may refer to different locations within different layout diagrams, and they can also refer to different nodes within cross sections of different semiconductor structures.

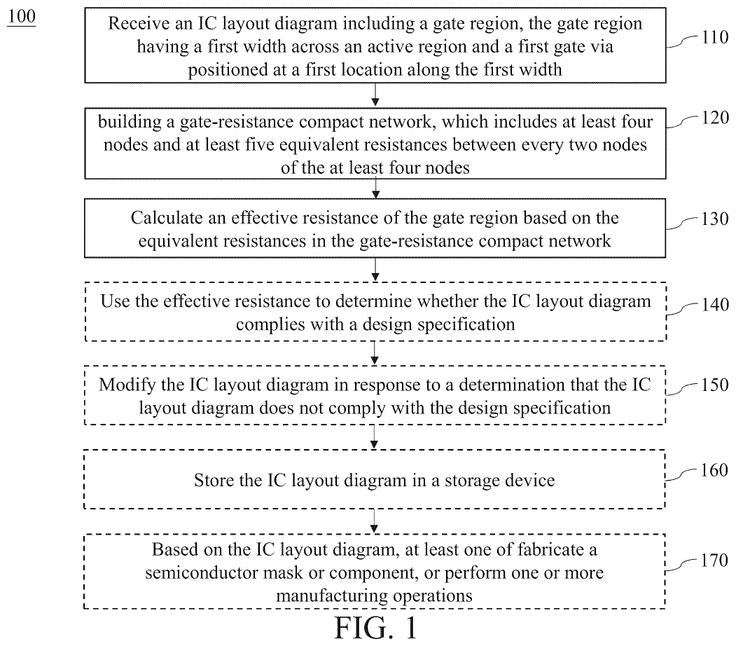

FIG. 1 is a flowchart of a method of manufacturing an IC device in accordance with some embodiments of the present disclosure. In some embodiments, manufacturing the IC device includes generating a layout diagram of the IC device. In some embodiments, generating the layout diagram of the IC device includes modeling the IC device based on an initial layout diagram of the IC device, and the initial layout diagram includes a gate region having a width across an active region and at least one gate via at a location along the width. In some embodiments, modeling the IC device includes modeling the gate region using a 5-resistor diamond gate-resistance network.

In some embodiments, modeling the IC device includes modeling a transistor, e.g., a planar transistor, a fin field-effect transistor (FinFET), a nanosheet FET, a nanowire FET, or other suitable types of transistors. In some embodiments, the transistor is one transistor of a plurality of transistors included in the IC device, non-limiting examples of which include memory circuits, logic devices, processing devices, signal processing circuits, or the like.

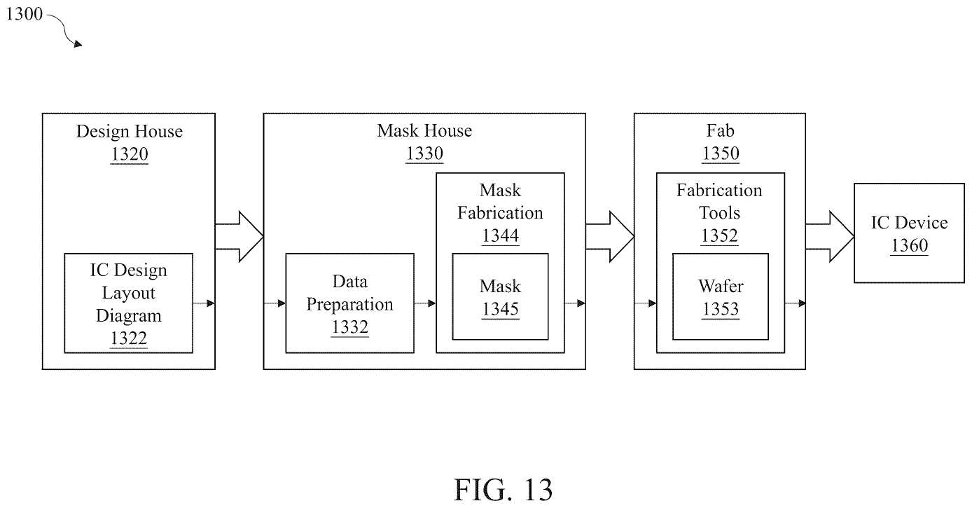

In some embodiments, some or all of method 100 is executed by a processor of a computer. In some embodiments, some or all of method 100 is executed by a processor 1202 of an EDA system 1200, discussed below with respect to FIG. 12. Some or all of the operations of method 100 are capable of being performed as part of a design procedure performed in a design house, e.g., a design house 1320 discussed below with respect to FIG. 13.

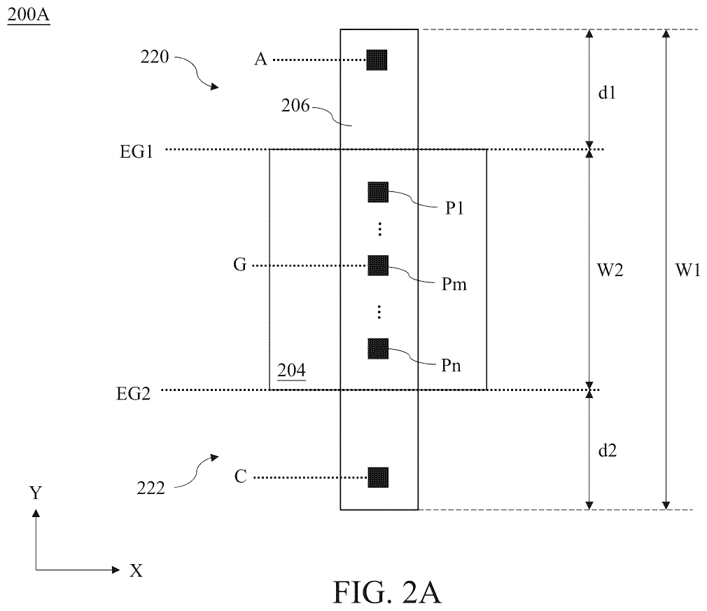

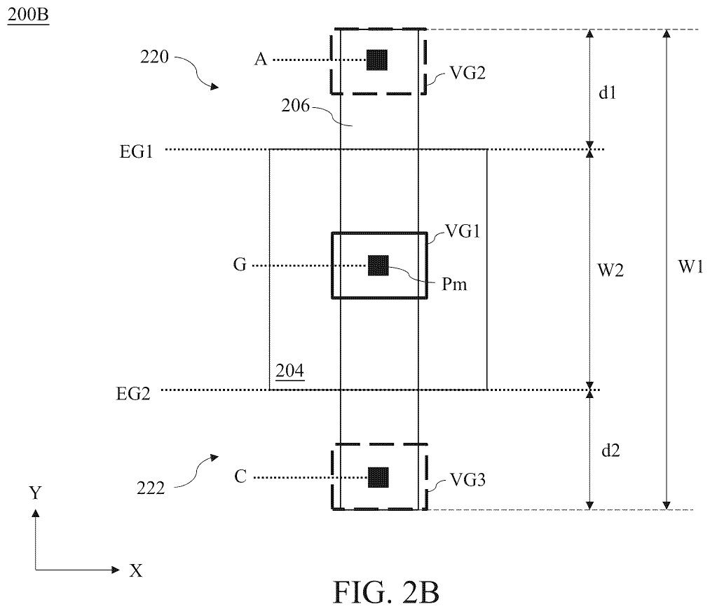

In some embodiments, the operations of method 100 are performed in the order depicted in FIG. 1. In some embodiments, the operations of method 100 are performed in an order other than the order depicted in FIG. 1. In some embodiments, one or more operations are performed before, between, during, and/or after performing one or more operations of method 100. The operations of method 100 are illustrated using FIGS. 2A-2B, 3A-3B, 4A-4B, 5A-5B, 6A-6F, 7A-7D, 8A-8C, 9A-9F, 10A-10F, and 11A-11H as discussed below.

FIG. 2A is a layout diagram of an IC device illustrating a plurality of locations on a gate region in accordance with some embodiments of the present disclosure. FIG. 2B is a layout diagram of an IC device illustrating gate vias disposed on the gate region in the layout diagram in accordance with the embodiment of FIG. 2A.

In some embodiments, the layout diagram 200A has a direction X and a direction Y perpendicular to direction X. The orientations of the layout diagrams 200A and 200B depicted with respect to directions X and Y are non-limiting examples used for the purpose of illustration. In some embodiments, the layout diagrams 200A and 200B may have an orientation with respect to directions X and Y other than that depicted in FIGS. 2A and 2B.

In some embodiments, the layout diagram 200A includes an active region 204, a gate region 206, and isolation regions 220 and 222. Active region (AR) 204 is a region in the layout diagram included in a manufacturing process as part of defining an active area, also referred to as an oxide diffusion or definition (OD), in a semiconductor substrate in which one or more IC device features, e.g., a source/drain region, is formed. In various embodiments, an active area is an N-type or P-type active area of a planar transistor, a FinFET, or a nanosheet FET. In some embodiments, gate region 206 is a region in the layout diagram included in the manufacturing process as part of defining a gate structure in the IC device including at least one of a conductive material or a dielectric material. In various embodiments, the gate structure corresponding to gate region 206 includes at least one conductive material, e.g., a metal and/or a polysilicon material, overlying at least one dielectric material, e.g., a silicon dioxide and/or a high-k dielectric material.

In some embodiments, active region 204 is formed between the isolation regions 220 and 222, which may be shallow trench isolation (STI) regions. Edge EG1 exists between active region 204 and isolation region 220, while edge EG2 exists between active region 204 and isolation region 222. In some embodiments, location A can be set on a first edge of gate region 206 overlapping with the isolation region 220, while location C can be set on a second edge opposite to the first edge of gate region 206 overlapping with the isolation region 222. Additionally, a plurality of locations P1 to Pn can be set on gate region 206 overlapping with active region 204. Location P1 and Pn may be located at a first edge and a second edge opposite of the first edge of the active region 204. Gate region 206 extends across active region 204 and isolation regions 220 and 222 from location A on the first edge of gate region 206 to location C on the second edge opposite to the first edge of gate region 206, thereby defining a width W1 along direction Y. In particular, gate region 206 has a width W2, d1, and d2 across active region 204 and isolation regions 220 and 222 along direction Y, respectively. Additionally, the widths d1 and d2 may be substantially equal. In some embodiments, location Pm, also referred to as location G, is a midway point along width W1 between locations A and C. In some embodiments, gate region 206 extends beyond one or both of locations A and C.

In some embodiments, one or more gate vias can be formed on gate region 206, such as gate via VG1 shown in FIG. 2B. For example, gate via VG1 may be disposed on gate region 206 overlapping with the active region 204. Additionally, depending on the design, gate via VG2 can be disposed on location A of gate region 206, while gate via VG3 can be disposed on location C of gate region 206. Each gate via VG1 to VG3, is a region in the layout diagram included in the manufacturing process as part of defining one or more segments of one or more conductive layers in the IC device configured to form an electrical connection between the gate structure corresponding to gate region 206 and one or more conductive layer segments overlying the gate structure corresponding to gate region 206. In various embodiments, the one or more conductive layer segments formed based on each gate via include a metal, e.g., copper, and forms an electrical connection to a metal zero, a metal one, or a metal two layer of the IC device.

In various embodiments, the layout diagrams 200A and 200B include features in addition to active region 204, gate region 206, and gate vias VG1 to VG3, e.g., one or more additional active regions, gate regions, and/or gate vias, and/or one or more isolation regions, source/drain regions, well regions, and/or interconnect features, that are not depicted in FIGS. 2A and 2B for the purpose of clarity.

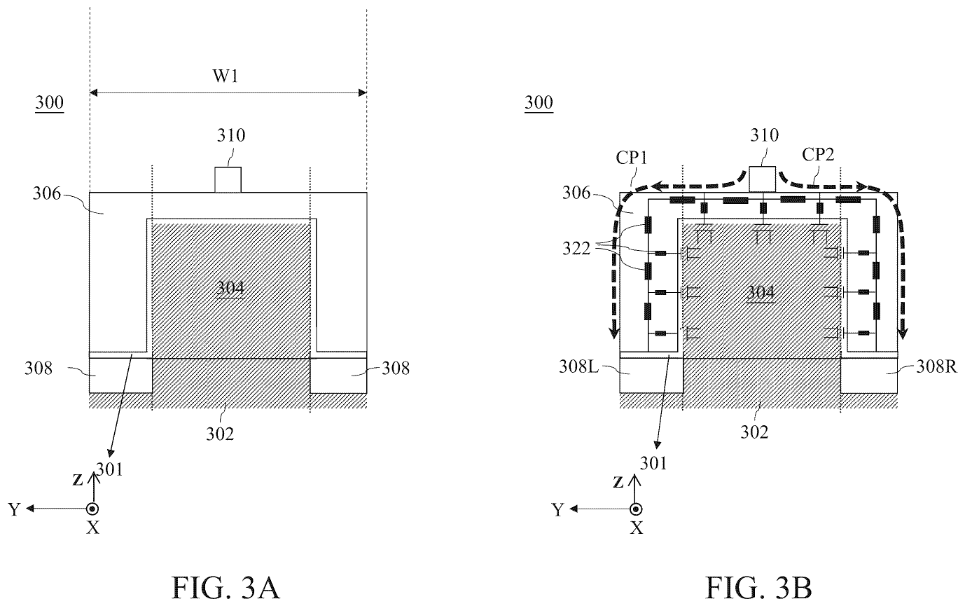

FIGS. 3A and 3B are diagrams of a semiconductor structure of a finFET in accordance with some embodiments of the present disclosure. Please refer to FIG. 2B and FIGS. 3A to 3B simultaneously.

In some embodiments, semiconductor structure 300 shown in FIG. 3A is a portion of a cross section of a finFET corresponding to the layout diagram 200B in FIG. 2B, which is a top view of the semiconductor structure 300. For example, semiconductor structure 300 includes a substrate 302 which includes fin 304 protruding upwardly. In some embodiments, semiconductor structure 300 further includes isolation regions 308 that are separated by fin 304, a gate dielectric layer 301 (e.g., silicon oxide) that is disposed over fin 304 and isolation regions 308, a gate electrode 306 that are disposed over the gate dielectric layer 301, and a gate via (or gate contact) 310 disposed on the gate electrode 306. Specifically, the gate electrode 306, fin 304, and gate via 310 in FIG. 3A may correspond to gate region 206, active region 204, and gate via VG1 in FIG. 2B, respectively. It should be noted that the total width of fin 304 and isolation regions 308 substantially equals to width W1 in the layout diagram 200B in FIG. 2B. For brevity, gate via 310 is disposed on the gate electrode 306 at the midway position (e.g., location Pm or G) along width W1.

In some embodiments, the gate dielectric layer 301 may be made of a high-k dielectric material, such as a metal oxide or silicate of hafnium, aluminum, zirconium, lanthanum, manganese, barium, titanium, lead, other suitable materials, or any combination thereof, and may be made by CVD, ALD, other suitable techniques, or any combination thereof. In some embodiments, the gate electrode 306 may be made of titanium nitride, titanium oxide, tantalum nitride, tantalum carbide, cobalt, ruthenium, aluminum, tungsten, other suitable materials, or any combination thereof, and may be made by physical vapor deposition (PVD), other suitable techniques, or any combination thereof.

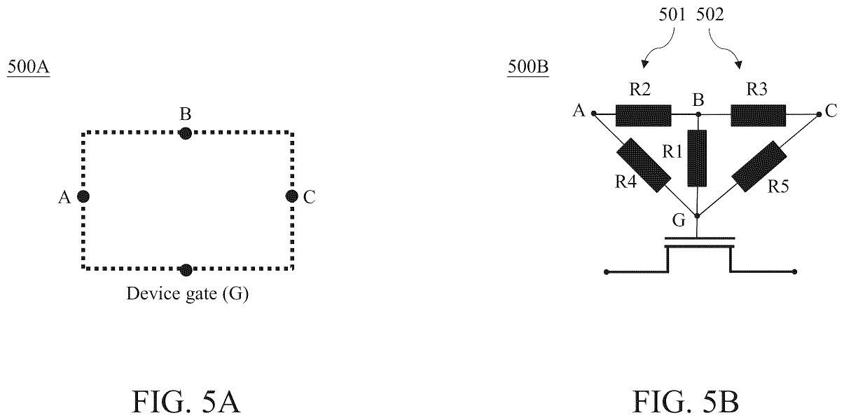

In some embodiments, when gate via 310 receives a voltage signal to activate the finFET corresponding to semiconductor structure 300, a signal path CP1 is established from gate via 310 to a first side of fin 304, and a signal path CP2 is established from gate via 310 to a second side of fin 304 opposite to the first side, thereby forming a channel around fin 304. Additionally, for purposes of description, equivalent (or effective) resistances 322 (e.g., solid black rectangles) corresponding to a plurality of segments within the gate electrode 306, along with the transistors formed on different sides of fin 304, are illustrated in FIG. 3B. These equivalent resistances 322 can be simplified and modeled using a 5-resistor diamond gate-resistance network, the details of which will be described with reference to the embodiments of FIGS. 5A and 5B.

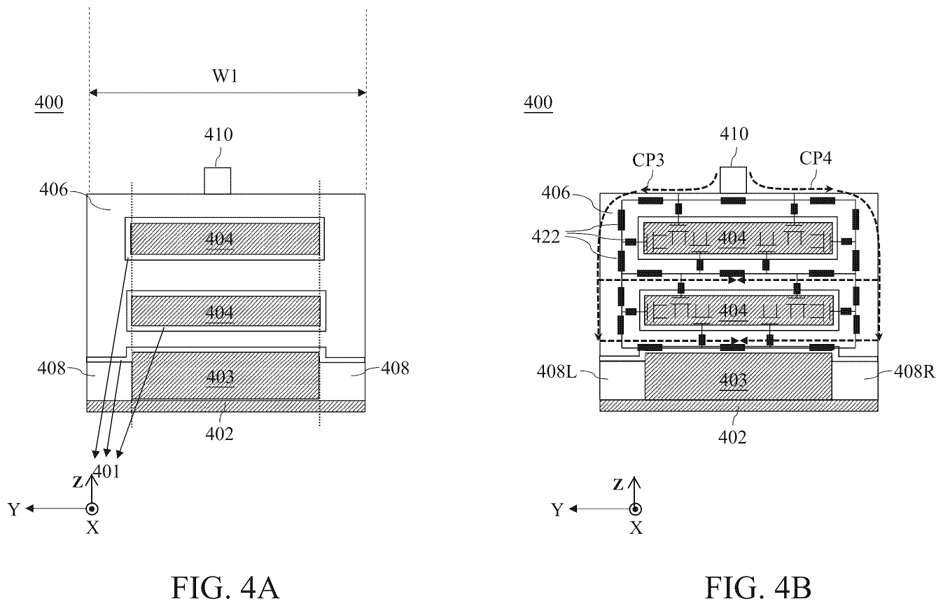

FIGS. 4A and 4B are diagrams of a semiconductor structure of a nanosheet FET in accordance with some embodiments of the present disclosure. Please refer to FIG. 2B and FIGS. 4A to 4B simultaneously.

In some embodiments, semiconductor structure 400 shown in FIG. 4A is a portion of a cross section of a nanosheet FET or a nanowire FET corresponding to the layout diagram 200B in FIG. 2B, which is a top view of the semiconductor structure 400. For example, semiconductor structure 400 includes a substrate 402, which includes fin 403 protruding upwardly. In some embodiments, semiconductor structure 400 further includes isolation regions 408 that are separated by fin 403, a plurality of nanostructures 404 that are disposed over substrate 402 and fin 403, a plurality of gate dielectric layers 401 that are disposed over substrate 402 and fin 403 and that surround the nanostructures 404, a gate electrode 406 that is disposed over the gate dielectric layers 401. Specifically, the gate electrode 406, nanostructures 404, and gate via 410 in FIG. 4A may correspond to gate region 206, active region 204, and gate via VG1 in FIG. 2B, respectively. It should be noted that the total width of nanostructures 404 and isolation regions 408 substantially equals to width W1 in the layout diagram 200B in FIG. 2B. For brevity, gate via 410 is disposed on the gate electrode 406 at the midway position (e.g., location Pm or G) along width W1.

In some embodiments, the gate dielectric layers 401 may be made of a high-k dielectric material, such as a metal oxide or silicate of hafnium, aluminum, zirconium, lanthanum, manganese, barium, titanium, lead, other suitable materials, or any combination thereof, and may be made by CVD, ALD, other suitable techniques, or any combination thereof. In some embodiments, the gate electrode 406 may be made of titanium nitride, titanium oxide, tantalum nitride, tantalum carbide, cobalt, ruthenium, aluminum, tungsten, other suitable materials, or any combination thereof, and may be made by physical vapor deposition (PVD), other suitable techniques, or any combination thereof.

In some embodiments, when gate via 410 receives a voltage signal to activate the nanosheet FET or nanowire FET corresponding to semiconductor structure 400, a signal path CP3 is established from gate via 410 to a first side of fin 403, and a signal path CP4 is established from gate via 410 to a second side of fin 403 opposite to the first side. Since the gate electrode 406 surrounds the nanostructures 404, a channel is formed within each nanostructure 404. Additionally, for purposes of description, equivalent resistances 322 (e.g., solid black rectangles) corresponding to a plurality of segments within the gate electrode 406, along with the transistors formed on different sides of each nanostructure 404, are illustrated in FIG. 4B. These equivalent resistances 422 can be simplified and modeled using a 5-resistor diamond gate-resistance network, the details of which will be described with reference to the embodiments of FIGS. 5A and 5B.

FIG. 5A is a diagram illustrating four nodes within a three-dimensional transistor architecture in accordance with some embodiments of the present disclosure. FIG. 5B is a diagram illustrating a 5-resistor diamond gate-resistance network in accordance with some embodiments of the present disclosure.

In some embodiments, four nodes A, B, C, and G can be built within a semiconductor structure of a 3D transistor, such as semiconductor structures 300 or 400, where nodes A, B, and C can be regarded as non-gate nodes, and node G is a gate node, as shown by diagram 500A in FIG. 5A. In some embodiments, node B may refer to the location of gate via 310 shown in FIG. 3A or gate via 410 shown in FIG. 4A. Nodes A and C may refer to the locations on two opposite edges of the gate region, and node G may refer to device gate, depending on the semiconductor structure of the transistor device.

In some embodiments, a 5-resistor diamond gate-resistance network 500B utilizing nodes A, B, C, and G is established to estimate the gate resistance of the finFET or nanosheet FET. For example, the principles for building the 5-resistor diamond gate-resistance network 500B are as follows. Each of non-gate nodes A, B, and C has at least two resistances connected thereto, while the gate node G has three resistors connected thereto. Additionally, gate node G is connected to each of non-gate nodes A to C. Accordingly, a 5-resistor diamond gate-resistance network 500B with four nodes can be built. Specifically, given that a “degree” represents the number of edges connected to a vertex or node, the degrees of the nodes A, B, C, and G are 2, 3, 2, and 3, respectively.

In some embodiments, using the concept of graph theory, nodes A, B, and G can be regarded as vertices of triangle mesh 501, where resistor R2 denotes the equivalent resistance between nodes A and B, resistor R4 denotes the equivalent resistance between nodes A and G, and resistor R1 denotes the equivalent resistance between nodes B and G. Similarly, nodes B, C, and G can be regarded as vertices of triangle mesh 502, where resistor R3 denotes the equivalent resistance between nodes B and C, resistor R5 denotes the equivalent resistance between nodes C and G, and resistor R1 denotes the equivalent resistance between nodes B and G.

In some embodiments, in a three-dimensional transistor architecture (e.g., semiconductor structure 300 for a finFET or semiconductor structure 400 for a nanosheet FET), it is permissible to land one or more gate vias on top of transistor devices, and thus the number of transient signal paths increases significantly (e.g., 10 paths or electrical requirements) as compared to a planar transistor architecture. Accordingly, the EDA tool may have to consider the horizontal gate resistance, vertical gate resistance, and inter-sheets gate resistance, leading to quite different process targets for effective gate resistance compared to planar transistor devices. Among 10 electrical requirements, five of them are selected to be representative signal paths which have impact to circuit performance. In some embodiments, the 10 electrical requirements may include, but are not limited to, equivalent resistances R_{A-G}, R_{B-G}, R_{C-G}, R_{AB-G}, R_{BC-G}, R_{AC-G}, R_{ABC-G}, R_{A-B}, R_{B-C}, and R_{A-C}.

For example, RA-G may represent the equivalent resistance of the gate region given that node A receives an input voltage signal and node G serves as an output node. Similarly, RAC-G may represent the equivalent resistance of the gate region given that nodes A and C are shorted and receive the same voltage signal or different voltage signals and node G serves as an output node. The other equivalent resistances among the 10 electrical requirements can be derived in a similar manner.

Accordingly, the 5-resistor diamond gate-resistance network 500B can be expressed as a half-edge data structure with two non-overlapping triangle meshes 501 and 502 sharing a common edge, such as resistor R1. It should be noted that the 5-resistor diamond gate-resistance network 500B is a “compact” network, indicating that none of nodes or resistors can be simplified by other nodes or resistors due to redundancy under such network structure. Therefore, 5 electrical requirements, such as resistances R_{B-G}, R_{AB-G}, R_{BC-G}, R_{ABC-G}, and R_{A-C}, can be selected for a layout diagram including a contact (e.g., gate via, abbreviated as VG) landing on the active region (e.g., abbreviated as OD or AR). The proposed 5-resistor diamond gate-resistance network can be used to solve five process targets of five equations.

In some embodiments, the resistances R_{B-G}, R_{AB-G}, R_{BC-G}, R_{ABC-G}, and R_{A-C} can be modeled using equations (1) to (5) as follows.

$${R}_{B - G} = R 1 // ( R 2 + R4 ) // ( R 3 + R 5 ) = R g / a \qquad ( 1 )$$

$${R}_{AB - G} = R 1 \cdot R 4 // ( R 3 + R 5 ) = Rg / b \qquad ( 2 )$$

$${R}_{BC - G} = R 5 // R 1 // ( R 2 + R 4 ) = R g / c \qquad ( 3 )$$

$${R}_{ABC - G} = R 1 // R 4 // R 5 = Rg / d \qquad ( 4 )$$

$${R}_{A - C} = F 2 + ( R 2 + F 1 ) // ( R 4 + F 3 ) = Rg / e \qquad ( 5 )$$

In equations (1) to (5), Rg represent the effective gate resistance or the effective resistance of the gate region. The parameters F1, F2, and F3 used in equation (5) can be calculated using equations (6) to (8) as follows.

$$F 1 = R 1 * R 3 / ( R 1 + R 3 + R 5 ) \qquad ( 6 )$$

$$F 2 = R 3 * R 5 / ( R 1 + R 3 + R 5 ) \qquad ( 7 )$$

$$F 3 = R 1 * R 5 / ( R 1 + R 3 + R 5 ) \qquad ( 8 )$$

Accordingly, the EDA tool can compute at least one rational solution set Ri (i=1 to 5) for five process targets of five equations, indicating that the values a to e in equations (1) to (5) can be computed to obtain the effective gate resistance Rg.

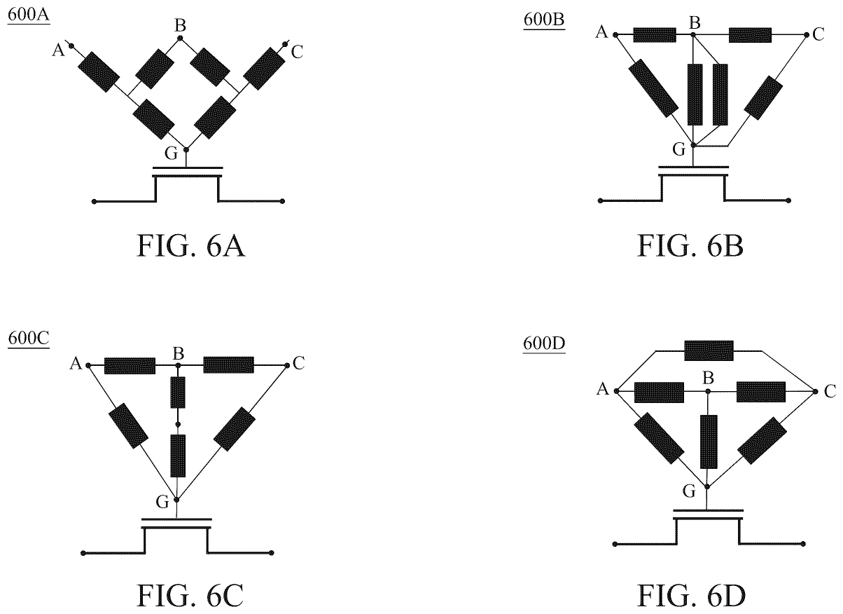

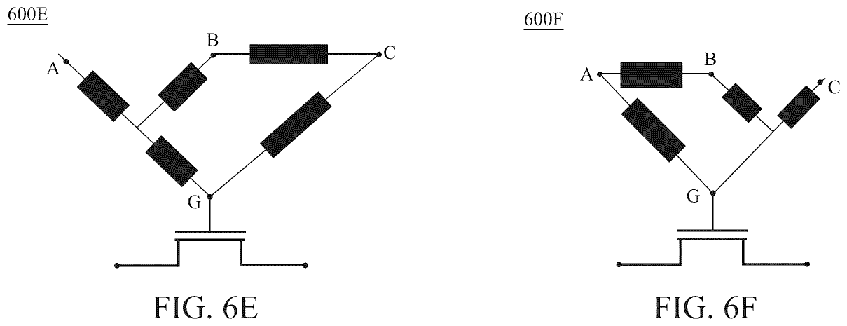

FIGS. 6A to 6F illustrate different networks 600A to 600F, which are equivalent to the 5-resistor diamond gate-resistance network 500B shown in FIG. 5B using the delta-star transformation technique, with nodes A, B, C, and G labeled. In some embodiments, any equivalent network obtained from the 5-resistor diamond gate-resistance network 500B shown in FIG. 5B using delta-star transformation is also within the scope of the present disclosure. The delta-star transformation is a mathematical technique used in circuit analysis to simplify complex resistor networks. It allows for the conversion between a delta (Δ) configuration and a star (Y) configuration, making it easier to analyze circuits that cannot be simplified using series and parallel combinations alone. In a delta configuration, three resistors are connected in a triangle, while in a star configuration, three resistors are connected in a Y shape, with a common central node. The transformation involves calculating equivalent resistances for each configuration so that the electrical behavior (in terms of resistance between any two terminals) remains the same.

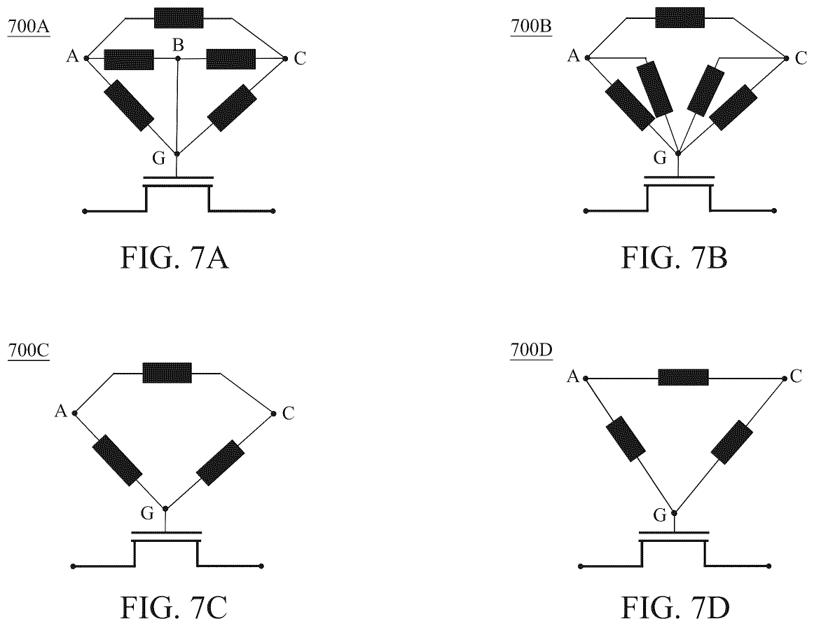

In some embodiments, a network with redundant resistors, which can be simplified using the delta-star transformation technique, cannot be treated as a “compact network”. For example, although network 700A shown in FIG. 7A includes four nodes A, B, C, and G, network 700A include redundant resistors and can be simplified to network 700B shown in FIG. 7B. For example, since no equivalent resistance exists between nodes B and G, node B is eliminated from network 700A by simplification to obtain network 700B. However, network 700B shown in FIG. 7B is not a compact network yet because two resistors are shunt between nodes A and G, and two resistors are shunt between nodes C and G. Thus, network 700B can be simplified to network 700C with three nodes A, C, and G and three resistors, as depicted in FIG. 7C. Additionally, since the resistor between nodes A and C within network 700C is not on the shortest path between nodes A and C, network 700C can be further simplified to network 700D shown in FIG. 7D. Network 700D can be considered as a metric space, which is compact in the topological sense. However, due to absence of node B, network 700D is not equivalent to the 5-resistor diamond gate-resistance network 500B.

Attention now is directed back to FIG. 2B, where a single gate via VG1 is disposed at location G of gate region 206 (e.g., excluding gate vias VG2 and VG3). For purposes of description, the layout diagram 200B may correspond to the semiconductor structure 300 of a finFET shown in FIG. 3A or the semiconductor structure 400 of a nanosheet FET shown in FIG. 4A. For brevity, it is assumed that gate region 206 has a fixed resistance of approximately 1000 ohms from location A to C. Geometrically, the equivalent resistance R_{A-G} from location A to location G is approximately 500 ohms. Furthermore, utilizing the proposed 5-resistor diamond gate-resistance network, the EDA tool can also calculate the equivalent resistance R_{A-G} from location A to location G as approximately 500 ohms, and the resistance R_{B-G} from location B to location G as approximately 300 ohms for a finFET, or approximately 450 ohms for a nanosheet FET.

In some other embodiments, two gate vias VG1 and VG2 are disposed at locations G and A of the gate region 206 (e.g., excluding gate via VG3), respectively. Geometrically, the equivalent resistance R_{A-G} from location A to location G is approximately 500 ohms. Furthermore, utilizing the proposed 5-resistor diamond gate-resistance network, the EDA tool can calculate the equivalent resistance R_{A-G} from location A to location G as approximately 300 ohms, and the resistance R_{B-G} from location B to location G as approximately 100 ohms for a finFET, or approximately 250 ohms for a nanosheet FET. Specifically, when two gate vias 810 and 811 disposed on different locations of gate region 806 are supplied with the same voltage signal simultaneously, the equivalent resistances R_{A-G} and R_{B-G} decrease correspondingly based on the proposed 5-resistor diamond gate-resistance network, thereby precisely reflect the actual equivalent gate resistance of a finFET or nanosheet FET.

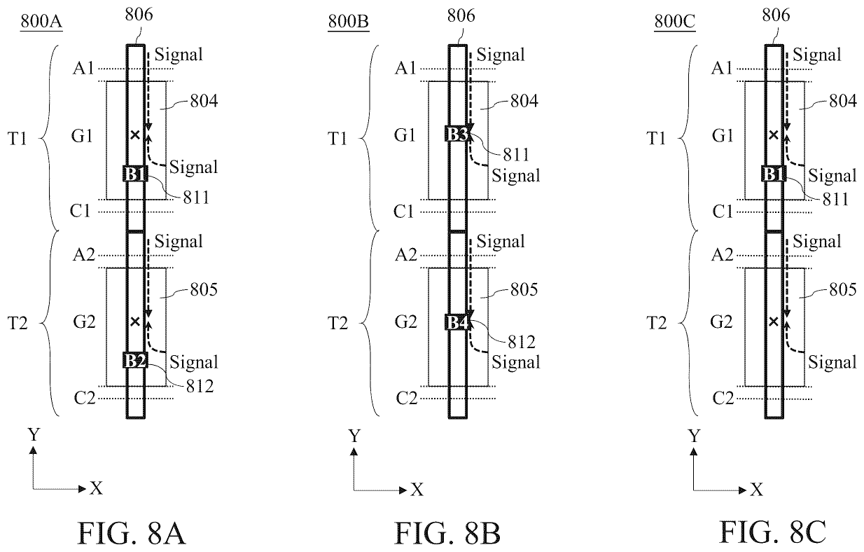

FIGS. 8A to 8C are layout diagrams illustrating a gate region extending across two transistor devices with different locations of gate vias disposed thereon, in accordance with some embodiments of the present disclosure.

In some embodiments, the layout diagrams 800A to 800C in FIGS. 8A to 8C are similar, with the difference being the locations of gate vias B1 and B2 disposed on the gate region 806. Referring to FIG. 8A, layout diagram 800A includes two transistor devices T1 and T2 arranged in a cascode structure, which may be finFETs or nanosheet FETs. Transistor device T1 includes an active region 804 and a gate region 806, while transistor device T2 includes an active 805 and the gate region 806, which extends from location A1 of transistor device T1 to location C2 of transistor device T2. For purposes of description, A1 and C1 denotes the edge locations of the gate region 806 within transistor device T1, G1 denotes the middle position between locations A1 and C1, and B1 denotes the location of a first gate via 811 disposed on the gate region 806, such as a location of ¾ width of the gate region 806, which starts from location A1, within transistor device T1. Similarly, A2 and C2 denotes the edge locations of the gate region 806 within transistor device T2, G2 denotes the middle position between locations A2 and C2, and B2 denotes the location of a second gate via 812 disposed on the gate region 806, such as a location of ¾ width of the gate region 806, which starts from location A2, within transistor device T2. Additionally, the distance from location A1 to C1 substantially equals that from location A1 to C2.

In some embodiments, for brevity, it is assumed that gate region 806 has a fixed resistance of approximately 2000 ohms from location A1 to C2 in FIGS. 8A to 8C, indicating that the resistances from A1 to C1 and from A2 to C2 are both approximately 1000 ohms. Referring to FIG. 8A, geometrically, the equivalent resistance R_{B1-G1} from location B1 to location G1 is approximately 250 ohms, and the equivalent resistance R_{B2-G2} from location B2 to location G2 is also approximately 250 ohms. In some embodiments, transistor devices T1 and T2 share the common gate region 806, and the first gate via 811 at location B1 and the second gate via 812 at location B2 are supplied with the same voltage signal simultaneously to turn on transistor devices T1 and T2. Accordingly, utilizing the proposed 5-resistor diamond gate-resistance network, the EDA tool can calculate the equivalent resistances R_{B1-G1} and R_{B2-G2} as approximately 200 ohms.

Referring to FIG. 8B, location B3 overlaps with location G1, and location B4 overlaps location G2, indicating that the first gate via 811 of transistor device T1 is disposed at the midway location of gate region 806 within transistor device T1, and the second gate via 812 of transistor device T2 is disposed at the midway location of gate region 806 within transistor device T2. Geometrically, the equivalent resistance R_{B3-G1} from location B3 to location G1 is approximately 0 ohms, and the equivalent resistance R_{B4-G2} from location B4 to location G2 is also approximately 0 ohms. In some embodiments, transistor devices T1 and T2 share the common gate region 806, and the first gate via at location B3 and the second gate via at location B4 are supplied with the same voltage signal simultaneously to turn on transistor devices T1 and T2. Accordingly, utilizing the proposed 5-resistor diamond gate-resistance network, the EDA tool can calculate the equivalent resistances R_{B1-G1} and R_{B2-G2} as approximately 100 ohms, which are different from the geometrically estimated equivalent resistances.

Referring to FIG. 8C, the first gate via 811 is disposed on location B1, and the second gate via 812 is absent. Geometrically, the equivalent resistance R_{B1-G1} from location B1 to location G1 is approximately 250 ohms, and the equivalent resistance R_{B1-C2} from location B1 to location C2 is also approximately 1250 ohms. In some embodiments, transistor devices T1 and T2 share the common gate region 806, and the first gate via at location B1 is supplied with a voltage signal to turn on transistor devices T1 and T2. Accordingly, utilizing the proposed 5-resistor diamond gate-resistance network, the EDA tool can calculate the equivalent resistances R_{B1-G1} and R_{A2-C2} as approximately 200 ohms and 800 ohms, respectively.

Accordingly, it can be understood that the equivalent resistances may vary depending on the number and locations of the gate vias disposed on the gate region, as described in the embodiments of FIGS. 8A to 8C.

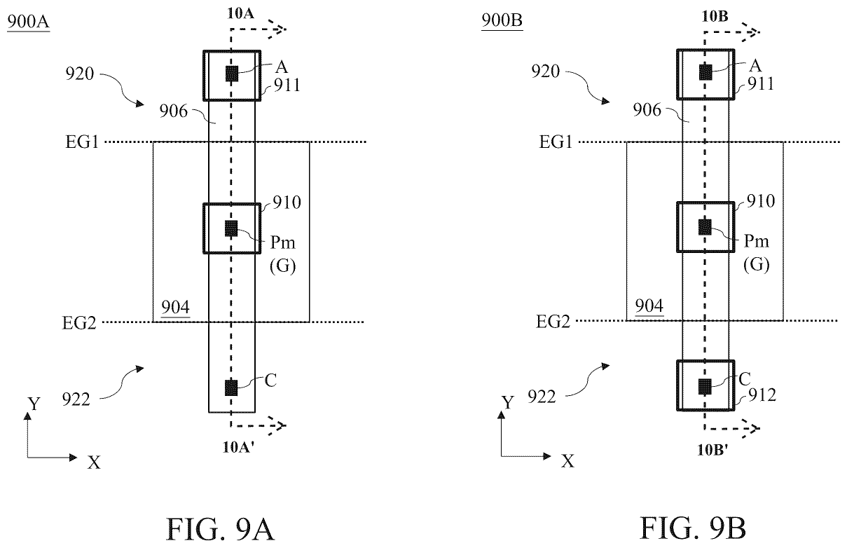

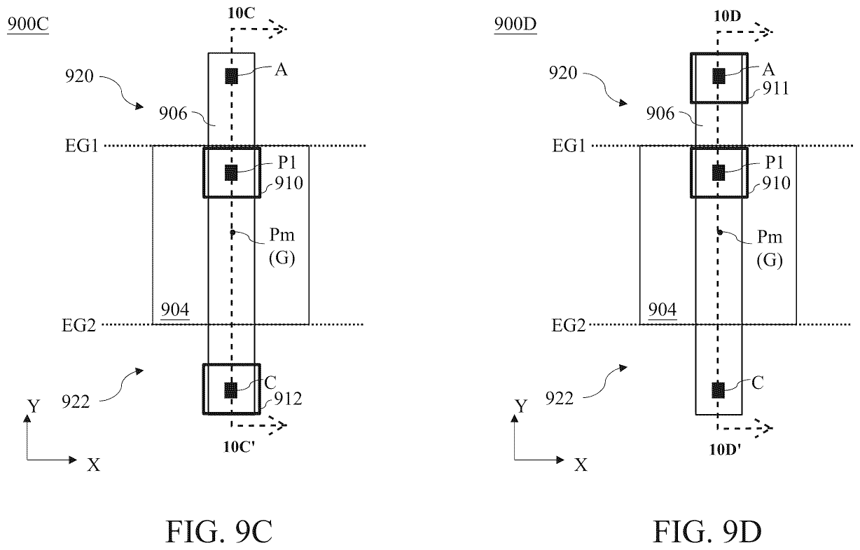

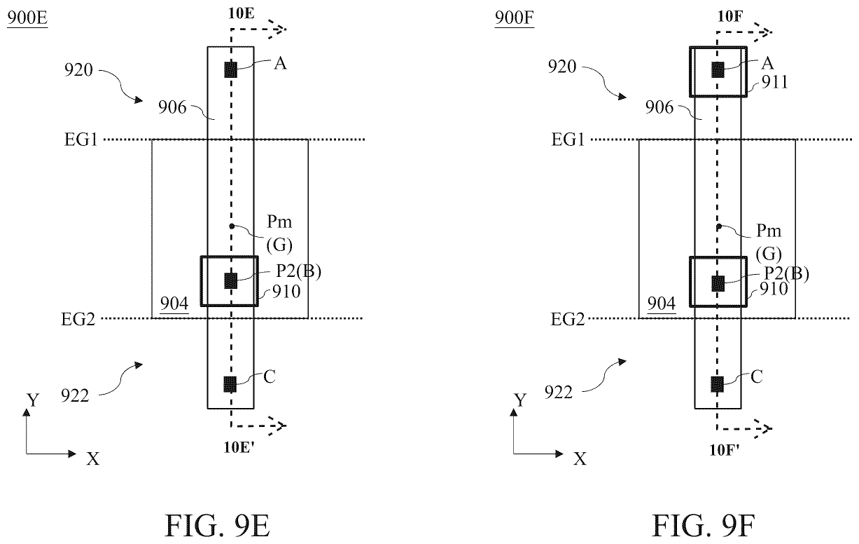

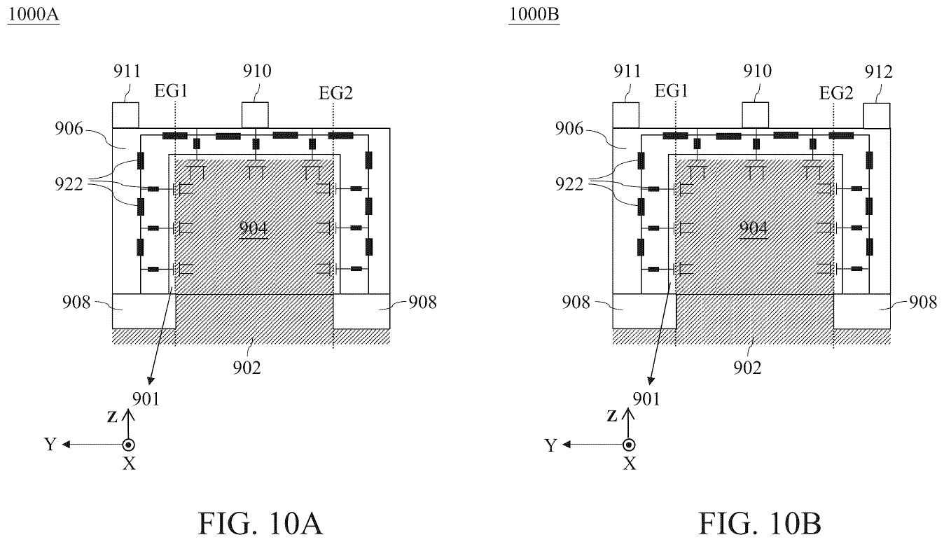

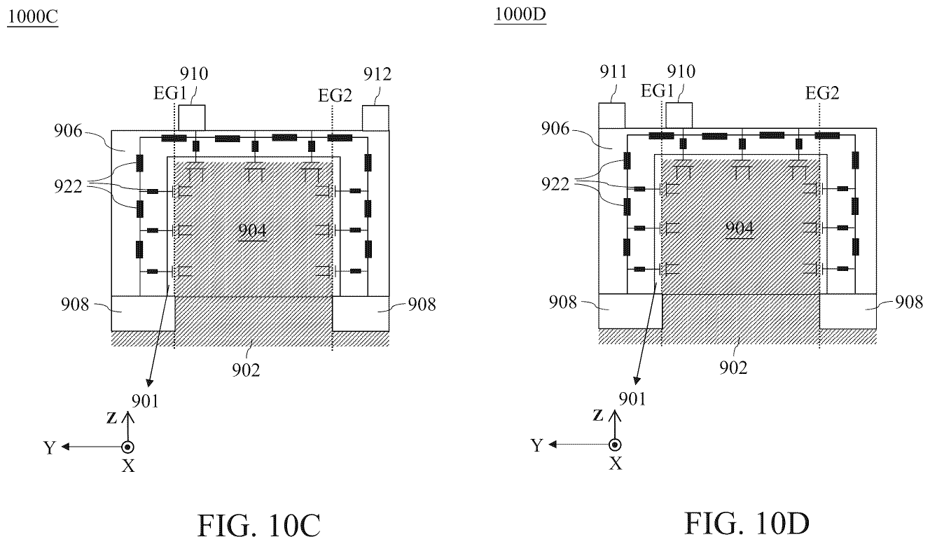

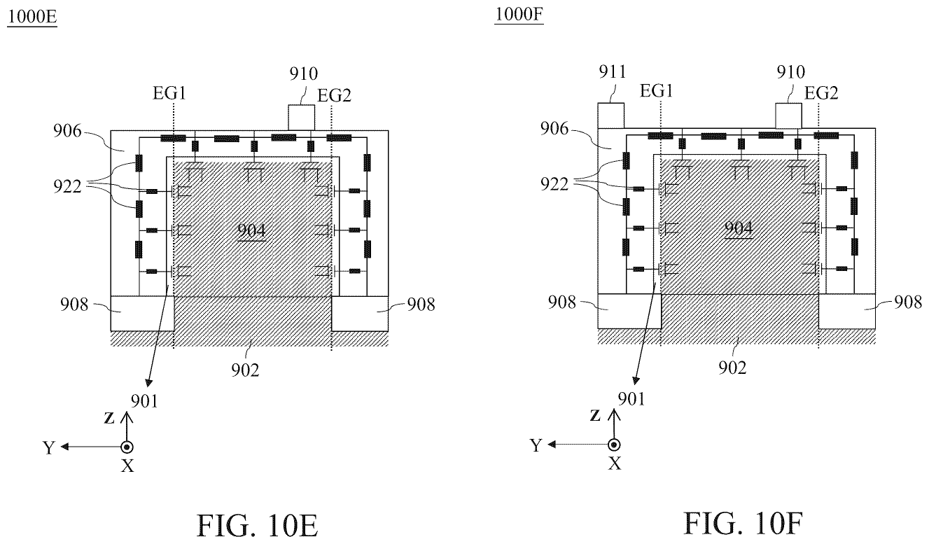

FIGS. 9A to 9F are layout diagrams of various arrangements of gate vias in accordance with different embodiments of the present disclosure. FIGS. 10A to 10F are cross sections corresponding to the layout diagrams in FIGS. 9A to 9F. FIG. 10A corresponds to section line 10A-10A′ in FIG. 9A. FIG. 10B corresponds to section line 10B-10B′ in FIG. 9B. FIG. 10C corresponds to section line 10C-10C′ in FIG. 9C. FIG. 10D corresponds to section line 10D-10D′ in FIG. 9D. FIG. 10E corresponds to section line 10E-10E′ in FIG. 9E. FIG. 10F corresponds to section line 10F-10F′ in FIG. 9F.

In some embodiments, layout diagrams 900A to 900F shown in FIGS. 9A to 9F corresponds to semiconductor structures 1000A to 1000F shown in FIGS. 10A to 10F. The layout diagrams 900A to 900F may be similar, with the difference being that the number of gate vias disposed on the gate region 906. Referring to FIG. 9A, layout diagram 900A includes an active region 904 and a gate region 906. Active region 904 is formed between the isolation regions 920 and 922, which may be shallow trench isolation (STI) regions. Edge EG1 exists between active region 904 and isolation region 920, while edge EG2 exists between active region 904 and isolation region 922. In some embodiments, location A can be set on a first edge of gate region 906 overlapping with the isolation region 920, while location C can be set on a second edge opposite to the first edge of gate region 906 overlapping with the isolation region 922. Gate vias 910 and 911 are disposed at locations Pm (G) and A, respectively. Location Pm (G) may refer to the midway location of the gate region 906 from location A to location C. Referring to FIG. 10A, semiconductor structure 1000A is similar to semiconductor structure 300 in FIG. 3A, and thus the details thereof will not be repeated here. As can be seen from semiconductor structure 1000A in FIG. 10A, the gate vias 910 and 911 are separated along direction Y.

Referring to FIG. 9B, gate vias 910, 911, and 912 are disposed at locations Pm (G), A, and C, respectively. Additionally, as can be seen from semiconductor structure 1000B in FIG. 10B, the gate vias 910, 911, and 912 are separated along direction Y.

Referring to FIG. 9C, gate vias 910 and 912 are disposed at locations B1 and C, respectively. Location P1 may refer to a location having a ¼ width of the gate region 906 from location A. Additionally, as can be seen from semiconductor structure 1000C in FIG. 10C, the gate vias 910 and 912 are separated along direction Y.

Referring to FIG. 9D, gate vias 910 and 911 are disposed at locations B1 and A, respectively. Additionally, as can be seen from semiconductor structure 1000D in FIG. 10D, the gate vias 910 and 911 are separated along direction Y.

Referring to FIG. 9E, gate via 910 are disposed at location P2. Location P2 may refer to a location having a ¾ width of the gate region 906 from location A. Additionally, as can be seen from semiconductor structure 1000E in FIG. 10E, the gate via 910 is disposed at the corresponding location.

Referring to FIG. 9F, gate vias 910 and 911 are disposed at locations P2 and A, respectively. Additionally, as can be seen from semiconductor structure 1000F in FIG. 10F, the gate vias 910 and 911 are separated along direction Y.

It should be noted that the different arrangements of gate vias within layout diagram 900A to 900F have a gate via landing on top of the active region (e.g., VG on OD), and the proposed 5-resistor diamond gate-resistance network can be utilized to calculate different equivalent resistances based on the position of the gate via on the layout diagram, thereby meeting the five process targets of five equations, as shown in equations (1) to (5).

In some embodiments, the EDA tool may have to consider two different conditions with the layout of one gate via landing on the active region, as shown in FIG. 9E. Location P2 may refer to node B in the proposed 5-resistor diamond gate-resistance network. Condition 1 may indicate that the input voltage signal is from a single side (e.g., location B), and the equivalent resistance R_{B-G} is to be calculated. Condition 2 may indicate that the input voltage signal is from two sides (e.g., locations A and B), and the equivalent resistance R_{AB-G} is to be calculated. Conditions 1 and 2 may occur independently during simulation. However, in some approaches, less than five resistors are used in the network model, and the equivalent resistances R_{B-G} and R_{AB-G} may be set to the same resistance value, resulting in big difference compared to process targets. With the proposed 5-resistor diamond gate-resistance network, the EDA tool can treat the equivalent resistances R_{B-G} and R_{AB-G} independently and accurately based on different simulation signal conditions. Accordingly, the proposed 5-resistor diamond gate-resistance network can generate gate-resistance (Rg) topology which provides accurate effective resistances for all the corresponding signal paths, thereby better representing the physical results of Rg-sensitive designs.

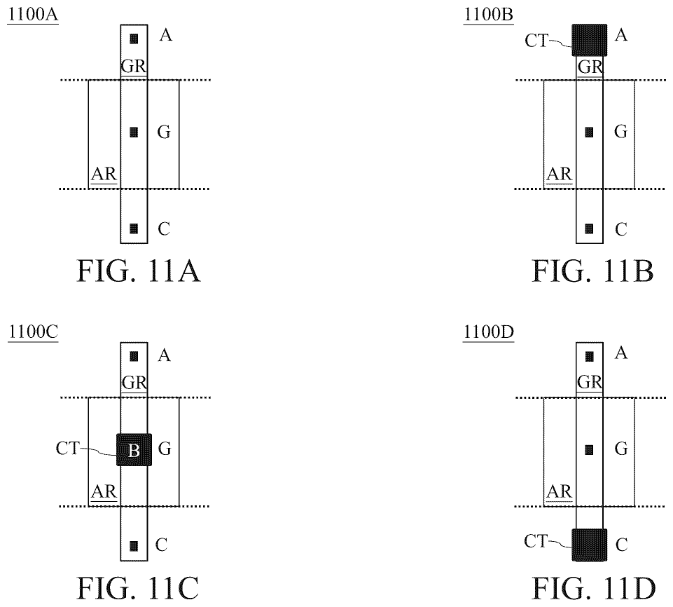

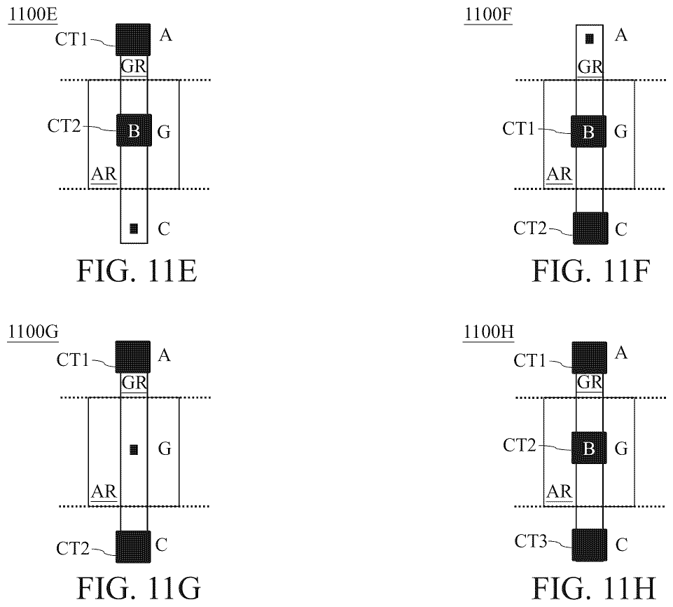

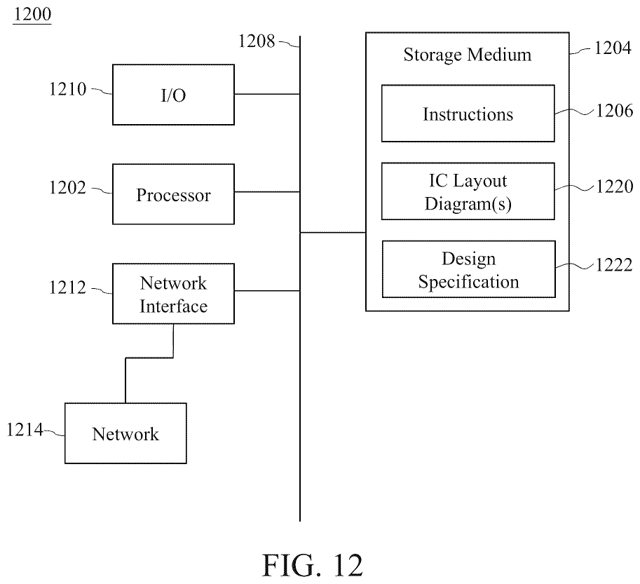

FIGS. 11A to 11H are layout diagrams illustrating different arrangements of gate via(s) in accordance with some embodiments of the present disclosure.

In some embodiments, layout diagrams 1100A to 1100H in FIGS. 11A to 11H may refer to layout cases 1 to 8, respectively. For brevity, active region AR, gate region GR, and locations A, B, C, and G are labeled in layout diagrams 1100A to 1100H. Referring to FIG. 11A, no gate via is disposed on the gate region GR in layout case 1. Referring to FIGS. 11B to 11D, a single gate via CT is disposed at different locations A, B, and C in layout diagrams 1100B to 1100D, respectively. Referring to FIGS. 11E to 11G, two gate vias CT1 and CT2 are disposed on different locations on the gate region GR. Referring to FIG. 11H, three gate vias CT1, CT2, and CT3 are disposed on locations A, G, and C, respectively. It should be noted that FIGS. 11C, 11E, 11F, and 11H, which correspond to layout cases 3, 5, 6, and 8, have a gate via landing on the active region AR.

In some embodiments, referring to FIGS. 11A, 11B, 11D, and 11G, which correspond to layout cases 1, 2, 4, and 7, since there is no contact node B, signal paths related to node B are not considered.

In some embodiments, referring to FIG. 11C, which corresponds to layout case 3, the voltage signal goes from the gate via CT into the device gate (e.g., node G). In these embodiments, when the voltage signal goes from the gate via CT into the device gate (e.g., node G), then indicating that the effective resistance R_{B-G} is the relatively greater significance, and the voltage of other nodes is smaller than that of the gate via at node B. Therefore, the EDA tool may treat other effective resistances R_{A-G}, R_{C-G}, R_{AC-G}, R_{A-B}, and R_{B-C} with lower priority, in accordance with some embodiments.

In some embodiments, referring to FIGS. 11E and 11F, which correspond to layout cases 5 and 6, the voltage signals go from two gate vias into the device gate, and the EDA tool may treat the effective resistances R_{AB-G} and R_{BC-G} as the electrical condition of interest for layout cases 5 and 6, respectively. For example, the effective resistance R_{B-G} is equivalent to the effective resistance R_{AB-G} because nodes A and B are at the same voltage potential. Additionally, other signal paths, R_{A-G}, R_{C-G}, R_{AC-G}, and R_{BC-G} (R_{AB-G}) may have limited impact to cell delay because the voltage at nodes A and C is smaller than that at node B.

Referring to FIG. 11H, which corresponds to layout case 8, the voltage signals go from three gate vias into the device gate, and the EDA tool may consider the effective resistance R_{ABC-G} as the electrical condition of interest. For example, effective resistances R_{B-G}, R_{AB-G}, and R_{BC-G} are equivalent to the effective resistance R_{ABC-G} because nodes A to C are in the same voltage potential. Additionally, other electrical conditions (R_{A-G}, R_{C-G}, and R_{AC-G}) have much smaller impact to cell delay than the effective resistance R_{ABC-G} because the voltage at nodes A to C are equal.

Accordingly, amongst the 10 electrical requirements that depend upon the arrangement of gate via(s) within the 8 layout cases, the effective gate resistance which has the most significant relative impact on performance is selected, and the selected effective gate resistance is monitored during simulation, in accordance with some embodiments.

Attention now is directed back to FIG. 1, and operations of method 100 are described as follows. Method 100 includes operations 110-170.

At operation 110, a layout diagram of the IC device is received. The layout diagram includes a gate region, the gate region having a width across an active region and a first gate via positioned at a first location along the width (e.g., for the scenario of “VG on OD”). The width extends from a first edge of the active region to a second edge of the active region opposite the first edge. In some embodiments, the width extends beyond the active region from location A to location C, which are located at opposite edges of the gate region extending from a first isolation region to a second isolation region through the active region.

The first location is between the first edge and second edge of the active region. In some embodiments, one or more additional gate vias, such as a second gate via and/or a third gate via, are disposed on opposite edge locations (e.g., location A, location C, or a combination) of the gate region overlapping with the first isolation region and the second isolation region.

Receiving the layout diagram includes receiving the layout diagram using a processor of a computer, e.g., processor 1202 of EDA system 1200, discussed below with respect to FIG. 12.

At operation 120, a gate-resistance network is built. The gate-resistance compact network includes at least four nodes of a three-dimensional transistor architecture represented by the layout diagram and at least five equivalent resistances correspondingly between each two ones of the at least four nodes. In some embodiments, the four nodes includes a gate node (e.g., G), and first to third non-gate nodes (e.g., B, A, and C). The gate node is positioned at a fin structure within the three-dimensional transistor architecture. The first non-gate node is positioned at the first location of the first gate via. The second non-gate node is positioned at a first edge of the gate region overlapping with the first isolation region. The third non-gate node is positioned at a second edge of the gate region overlapping with the second isolation region, wherein the second edge is opposite to the first edge

At operation 130, an effective resistance of the gate region is calculated based on the equivalent resistances in the gate-resistance compact network. The effective resistance is expressed in terms of an expected resistance of a gate structure manufactured in accordance with the gate region. In some embodiments, the expected resistance is an expected resistance Rg of the gate structure corresponding to gate region G between locations corresponding to locations A and C along width W1, as discussed with respect to FIGS. 2A-5B.

At operation 140, in some embodiments, the effective resistance is used to determine whether or not the layout diagram complies with a design specification. In some embodiments, determining whether or not the layout diagram complies with the design specification includes performing a simulation based on the layout diagram.

In various embodiments, the design specification includes a speed of the IC, a noise performance of the IC, a transient response time of the IC, a cutoff frequency of the IC, or another circuit characteristic potentially affected by a gate resistance.

At operation 150, in some embodiments, the layout diagram is modified in response to a determination that the layout diagram does not comply with the design specification. In various embodiments, modifying the layout diagram includes one or more of changing the location of the first gate via along the first width or adding a second gate via and/or a third gate via respectively positioned at the first edge and the second edge of the gate region.

At operation 160, in some embodiments, the layout diagram is stored in a storage device. In various embodiments, storing the layout diagram in the storage device includes storing the layout diagram in a non-volatile, computer-readable memory or a cell library, e.g., a database, and/or includes storing the layout diagram over a network. In some embodiments, storing the layout diagram in the storage device includes storing the layout diagram over network 1214 of EDA system 1200, discussed below with respect to FIG. 12.

At operation 170, in some embodiments, at least one of one or more semiconductor masks or at least one component in a layer of a semiconductor IC is fabricated, or one or more manufacturing operations are performed based on the layout diagram. Fabricating one or more semiconductor masks or at least one component in a layer of a semiconductor IC, and performing one or more manufacturing operations, e.g., one or more lithographic exposures, based on the layout diagram are discussed below with respect to FIG. 13.

By executing some or all of the operations of method 100, an effective gate resistance of an IC device is modeled using a 5-resistor diamond gate-resistance compact network, which includes at least four nodes and five equivalent resistances therebetween, as part of generating a layout diagram of the IC device, thereby improving accuracy and avoiding estimating gate resistance values incorrectly due to different electrical conditions, compared to gate resistance modeling methods that utilizes less than five equivalent resistances for four nodes.

FIG. 12 is a block diagram of IC device design system 1200, in accordance with some embodiments of the present disclosure. One or more operations of method 100, discussed above with respect to FIG. 1, are implementable using IC device design system 1200, in accordance with some embodiments.

In some embodiments, IC device design system 1200 is a computing device including a hardware processor 1202 and a non-transitory computer-readable storage medium 1204. Non-transitory computer-readable storage medium 1204, amongst other things, is encoded with, i.e., stores, computer program code 1206, i.e., a set of executable instructions. Execution of instructions 1206 by hardware processor 1202 represents (at least in part) an IC device design system which implements a portion or all of, e.g., a method 100 discussed above with respect to FIG. 1 (hereinafter, the noted processes and/or methods).

Processor 1202 is electrically coupled to non-transitory computer-readable storage medium 1204 via a bus 1208. Processor 1202 is also electrically coupled to an I/O interface 1210 by bus 1208. A network interface 1212 is also electrically connected to processor 1202 via bus 1208. Network interface 1212 is connected to a network 1214, so that processor 1202 and non-transitory, computer-readable storage medium 1204 are capable of connecting to external elements via network 1214. Processor 1202 is configured to execute computer program code 1206 encoded in non-transitory computer-readable storage medium 1204 in order to cause IC device design system 1200 to be usable for performing a portion or all of the noted processes and/or methods. In one or more embodiments, processor 1202 is a central processing unit (CPU), a multi-processor, a distributed processing system, an application specific integrated circuit (ASIC), and/or a suitable processing unit.

In one or more embodiments, non-transitory computer-readable storage medium 1204 is an electronic, magnetic, optical, electromagnetic, infrared, and/or a semiconductor system (or apparatus or device). For example, non-transitory computer-readable storage medium 1204 includes a semiconductor or solid-state memory, a magnetic tape, a removable computer diskette, a random access memory (RAM), a read-only memory (ROM), a rigid magnetic disk, and/or an optical disk. In one or more embodiments using optical disks, non-transitory computer-readable storage medium 1204 includes a compact disk-read only memory (CD-ROM), a compact disk-read/write (CD-R/W), and/or a digital video disc (DVD).

In one or more embodiments, non-transitory computer-readable storage medium 1204 stores computer program code 1206 configured to cause IC device design system 1200 to be usable for performing a portion or all of the noted processes and/or methods. In one or more embodiments, non-transitory computer-readable storage medium 1204 also stores information which facilitates performing a portion or all of the noted processes and/or methods. In various embodiments, non-transitory computer-readable storage medium 1204 stores one or a combination of at least one layout diagram 1220 or at least one design specification 1222, each discussed above with respect to method 100 and FIGS. 1 to 11.

IC device design system 1200 includes I/O interface 1210. I/O interface 1210 is coupled to external circuitry. In various embodiments, I/O interface 1210 includes one or a combination of a keyboard, keypad, mouse, trackball, trackpad, display, touchscreen, and/or cursor direction keys for communicating information and commands to and/or from processor 1202.

IC device design system 1200 also includes network interface 1212 coupled to processor 1202. Network interface 1212 allows system 1200 to communicate with network 1214, to which one or more other computer systems are connected. Network interface 1212 includes wireless network interfaces such as BLUETOOTH, WIFI, WIMAX, GPRS, or WCDMA; or wired network interfaces such as ETHERNET, USB, or IEEE-1364. In one or more embodiments, a portion or all of the noted processes and/or methods, is implemented in two or more systems 1200.

IC device design system 1200 is configured to receive information through I/O interface 1210. The information received through I/O interface 1210 includes one or a combination of at least one design rule instructions, at least one set of criteria, at least one design rule, at least one DRM, and/or other parameters for processing by processor 1202. The information is transferred to processor 1202 via bus 1208. IC device design system 1200 is configured to transmit and/or receive information related to a user interface through I/O interface 1210.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a layout diagram is generated using a tool such as VIRTUOSO® available from CADENCE DESIGN SYSTEMS, Inc., or another suitable layout generating tool.

In some embodiments, the processes are realized as functions of a program stored in a non-transitory computer-readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

By being usable to implement one or more operations of method 100, as discussed above with respect to FIGS. 1 to 11, IC device design system 1200 and a non-transitory computer-readable recording medium, e.g., non-transitory computer-readable recording medium 1204, enable the benefits discussed above with respect to method 100.

FIG. 13 is a block diagram of IC manufacturing system 1300, and an IC manufacturing flow associated therewith, in accordance with some embodiments of the present disclosure. In some embodiments, based on a layout diagram, at least one of (A) one or more semiconductor masks or (B) at least one component in a layer of a semiconductor integrated circuit is fabricated using manufacturing system 1300.

In FIG. 13, IC manufacturing system 1300 includes entities, such as a design house 1320, a mask house 1330, and an IC manufacturer/fabricator (“fab”) 1350, that interact with one another in the design, development, and manufacturing cycles and/or services related to manufacturing an IC device 1360. The entities in system 1300 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1320, mask house 1330, and IC fab 1350 is owned by a single larger company. In some embodiments, two or more of design house 1320, mask house 1330, and IC fab 1350 coexist in a common facility and use common resources.

Design house (or design team) 1320 generates a design layout diagram 1322 based on method 100, discussed above with respect to FIGS. 1 to 11. design layout diagram 1322 includes various geometrical patterns that correspond to patterns of metal, oxide, or semiconductor layers that make up the various components of IC device 1360 to be fabricated. The various layers combine to form various IC features. For example, a portion of design layout diagram 1322 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1320 implements a proper design procedure including method 100, discussed above with respect to FIGS. 1 to 11, to form design layout diagram 1322. The design procedure includes one or more of logic design, physical design or place and route. design layout diagram 1322 is presented in one or more data files having information of the geometrical patterns. For example, design layout diagram 1322 can be expressed in a GDSII file format or DFII file format.

Mask house 1330 includes data preparation 1332 and mask fabrication 1344. Mask house 1330 uses design layout diagram 1322 to manufacture one or more masks 1345 to be used for fabricating the various layers of IC device 1360 according to design layout diagram 1322. Mask house 1330 performs mask data preparation 1332, where design layout diagram 1322 is translated into a representative data file (“RDF”). Mask data preparation 1332 provides the RDF to mask fabrication 1344. Mask fabrication 1344 includes a mask writer. A mask writer converts the RDF to an image on a substrate, such as a mask (reticle) 1345 or a semiconductor wafer 1353. The design layout diagram 1322 is manipulated by mask data preparation 1332 to comply with particular characteristics of the mask writer and/or requirements of IC fab 1350. In FIG. 13, mask data preparation 1332 and mask fabrication 1344 are illustrated as separate elements. In some embodiments, mask data preparation 1332 and mask fabrication 1344 can be collectively referred to as mask data preparation.

In some embodiments, mask data preparation 1332 includes optical proximity correction (OPC) which uses lithography enhancement techniques to compensate for image errors, such as those that can arise from diffraction, interference, other process effects and the like. OPC adjusts design layout diagram 1322. In some embodiments, mask data preparation 1332 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1332 includes a mask rule checker (MRC) that checks the design layout diagram 1322 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the design layout diagram 1322 to compensate for limitations during mask fabrication 1344, which may undo part of the modifications performed by OPC in order to meet mask creation rules.

In some embodiments, mask data preparation 1332 includes lithography process checking (LPC) that simulates processing that will be implemented by IC fab 1350 to fabricate IC device 1360. LPC simulates this processing based on design layout diagram 1322 to create a simulated manufactured device, such as IC device 1360. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine design layout diagram 1322.

It should be understood that the above description of mask data preparation 1332 has been simplified for the purposes of clarity. In some embodiments, data preparation 1332 includes additional features such as a logic operation (LOP) to modify the design layout diagram 1322 according to manufacturing rules. Additionally, the processes applied to design layout diagram 1322 during data preparation 1332 may be executed in a variety of different orders.

After mask data preparation 1332 and during mask fabrication 1344, a mask 1345 or a group of masks 1345 are fabricated based on the modified design layout diagram 1322. In some embodiments, mask fabrication 1344 includes performing one or more lithographic exposures based on design layout diagram 1322. In some embodiments, an electron-beam (e-beam) or a mechanism of multiple e-beams is used to form a pattern on a mask (photomask or reticle) 1345 based on the modified design layout diagram 1322. Mask 1045 can be formed in various technologies. In some embodiments, mask 1345 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1345 includes a transparent substrate (e.g., fused quartz) and an opaque material (e.g., chromium) coated in the opaque regions of the binary mask. In another example, mask 1345 is formed using a phase shift technology. In a phase shift mask (PSM) version of mask 1345, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1344 is used in a variety of processes. For example, such a mask(s) is used in an ion implantation process to form various doped regions in semiconductor wafer 1353, in an etching process to form various etching regions in semiconductor wafer 1353, and/or in other suitable processes.

IC fab 1350 includes fabrication tools 1352. IC fab 1350 is an IC fabrication business that includes one or more manufacturing facilities for the fabrication of a variety of different IC products. In some embodiments, IC Fab 1350 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1350 uses mask(s) 1345 fabricated by mask house 1330 to fabricate IC device 1360. Thus, IC fab 1350 at least indirectly uses design layout diagram 1322 to fabricate IC device 1360. In some embodiments, semiconductor wafer 1353 is fabricated by IC fab 1350 using mask(s) 1345 to form IC device 1360. In some embodiments, the IC fabrication includes performing one or more lithographic exposures based at least indirectly on design layout diagram 1322. Semiconductor wafer 1353 includes a silicon substrate or other proper substrate having material layers formed thereon. Semiconductor wafer 1353 further includes one or more of various doped regions, dielectric features, multilevel interconnects, and the like (formed at subsequent manufacturing steps).

An aspect of the present disclosure provides a method of generating an integrated circuit (IC) layout diagram of an IC device, which includes receiving the layout diagram of the IC device, the layout diagram including a gate region having a first width across an active region, and a first gate via positioned at a first location along the first width. A gate-resistance compact network, which includes at least four nodes of a three-dimensional transistor architecture represented by the layout diagram and at least five equivalent resistances between corresponding ones of the at least four nodes, is built. An effective resistance of the gate region using the equivalent resistances in the gate-resistance compact network is calculated, and the effective resistance is used to determine whether the layout diagram complies with a design specification.

Another aspect of the present disclosure provides an integrated circuit (IC) layout diagram generation system which includes a processor, and a non-transitory, computer readable storage medium including computer program code for one or more programs. The non-transitory, computer readable storage medium and the computer program code are configured to, with the processor, cause the system to: receive a layout diagram including a gate region having a first width across a first isolation region, an active region, and a second isolation region in sequence, a first gate via positioned at a first location along a second width across the active region; and a second gate via positioned at a first edge of the gate region; build a gate-resistance compact network which includes at least four nodes of a three-dimensional transistor architecture represented by the layout diagram and at least five equivalent resistances between corresponding ones of the at least four nodes; calculate an effective resistance of the gate region using the equivalent resistances in the gate-resistance compact network; and perform a circuit simulation based on the effective resistance.

Yet another aspect of the present disclosure provides a method of generating an integrated circuit (IC) layout diagram of an IC device, which includes receiving the layout diagram of the IC device. The layout diagram includes a gate region having a first width across an active region, and a first gate via positioned at a first location along the first width. At least four nodes of the layout diagram and a gate structure of the IC device are obtained; modeling the gate region using a gate-resistance network, which is equivalent to a compact network including the at least four nodes of the layout diagram and at least five equivalent correspondingly resistances between each two ones of the at least four nodes; and using the compact network to determine whether the layout diagram complies with a design specification.

In some embodiments, a method (of manufacturing an integrated circuit (IC) device) includes: receiving a layout diagram of an integrated circuit (IC) device, the layout diagram comprising: a gate region having a first width across an active region, and a first gate via at a first location along the first width; and building a gate-resistance compact network which includes at least four nodes of a three-dimensional transistor architecture represented by the layout diagram and at least five equivalent resistances between corresponding ones of the at least four nodes; determining an effective resistance of the gate region based on the equivalent resistances in the gate-resistance compact network; determining compliance of the effective resistance with a design specification; and where the effective resistance fails compliance, modifying the layout diagram to facilitate compliance.

In some embodiments, the gate region extends from a first isolation region to a second isolation region through the active region; and the gate region has a second width across the first isolation region, the active region, and the second isolation region.

In some embodiments, the at least four nodes include: a gate node at a gate structure of the three-dimensional transistor architecture; a first non-gate node at the first location of the first gate via; a second non-gate node at a first edge of the gate region overlapping with the first isolation region; and a third non-gate node at a second edge of the gate region overlapping with the second isolation region, the second edge being opposite to the first edge.

In some embodiments, the building a gate-resistance compact network includes: simplifying a precursor to the gate-resistance compact network using delta-star transformation to obtain the gate-resistance compact network.

In some embodiments, the gate-resistance compact network is equivalent to a half-edge structure with two non-overlapping triangle meshes sharing a common edge; and the common edge represents an equivalent resistance between the first non-gate node and the gate node.

In some embodiments, the layout diagram includes a second gate via at the first edge or the second edge of the gate region.

In some embodiments, the layout diagram includes a second gate via and a third gate via at the first edge and the second edge of the gate region, respectively.

In some embodiments, the method further includes, based on the layout diagram, at least one of: (A) making one or more photolithographic exposures; (B) fabricating one or semiconductor devices; or (C) fabricating at least one component in a layer of a semiconductor integrated circuit.

In some embodiments, the determining compliance includes: performing a simulation based on the layout diagram.

In some embodiments, the design specification includes a speed of the IC device.

In some embodiments, the modifying the layout diagram includes: changing the first location of the first gate; one or more of (i) adding a second gate via at a second location along the first width or at a first edge of the gate region or (ii) adding a third gate via a second edge of the gate region.

In some embodiments, a system for manufacturing an integrated circuit (IC) device, the system comprising a processor and a non-transitory computer readable storage medium including computer program code for one or more programs, the non-transitory computer readable storage medium, the computer program code and the processor being configured to cause the system at least to perform operations comprising: receiving an layout diagram of an IC device, the layout diagram including as follows, a gate region having a first width across a first isolation region, an active region, and a second isolation region, a first gate via at a first location along a second width across the active region, and a second gate via at a first edge of the gate region; building a gate-resistance compact network, which includes at least four nodes of a three-dimensional transistor architecture represented by the layout diagram and at least five equivalent resistances between corresponding ones of the at least four nodes; determining an effective resistance of the gate region based on the equivalent resistances in the gate-resistance compact network; and performing a circuit simulation based on the effective resistance.

In some embodiments, the at least four nodes include: a gate node at a gate structure of the three-dimensional transistor architecture; a first non-gate node, at the first location of the first gate via; a second non-gate node, at the first edge of the gate region overlapping with the first isolation region; and a third non-gate node, at a second edge of the gate region overlapping with the second isolation region, the second edge being opposite to the first edge.

In some embodiments, the computer readable storage medium, the computer program code and the processor are further configured to cause the system at least to do as follows including: regarding a precursor to the gate-resistance network, simplifying the precursor using delta-star transformation to obtain the gate-resistance compact network.

In some embodiments, the performing a circuit simulation includes: applying a first input voltage signal to the first gate via to estimate a first effective resistance of the gate region; and apply the first input voltage signal to the first gate via and the second gate via to estimate a second effective resistance of the gate region; and the computer readable storage medium, the computer program code and the processor are further configured to cause the system at least to do as follows including: determining compliance of each of the first effective resistance and the second effective resistance with a design specification.

In some embodiments, the layout diagram further includes: a third gate via at a second edge of the gate region, and the second edge is opposite to the first edge.

In some embodiments, the performing a circuit simulation includes: applying an input voltage signal to the first gate via, the second gate via, and the third gate via.

In some embodiments, the system further includes at least one of: a masking facility configured to fabricate one or more semiconductor masks based on the layout diagram; or a fabricating facility configured to fabricate at least one component in a layer of a semiconductor integrated circuit based on the layout diagram.

In some embodiments, a non-transitory computer-readable medium having stored thereon computer executable instructions representing a method of generating an integrated circuit (IC) layout diagram of an IC device, the computer executable instructions being executable by at least one processor to perform the method including: receiving the layout diagram of the IC device, the layout diagram including as follows, a gate region having a first width across an active region, and a first gate via, at a first location along the first width, selecting at least four nodes and a gate structure of the IC device; modeling the gate region using a gate-resistance compact network, including the at least four nodes and at least five equivalent resistances correspondingly between each two ones of the nodes of the at least four nodes; and determining compliance of the layout diagram with a design specification based on the gate-resistance compact network.

In some embodiments, the gate region extends from a first isolation region to a second isolation region through the active region; and the gate region has a second width across the first isolation region, the active region, and the second isolation region.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method of manufacturing an integrated circuit (IC) device, the method comprising:
receiving a layout diagram of an integrated circuit (IC) device, the layout diagram comprising:
a gate region having a first width across an active region, and
a first gate via at a first location along the first width; and
building a gate-resistance compact network which includes at least four nodes of a three-dimensional transistor architecture represented by the layout diagram and at least five equivalent resistances between corresponding ones of the at least four nodes;
determining an effective resistance of the gate region based on the equivalent resistances in the gate-resistance compact network;
determining compliance of the effective resistance with a design specification; and
where the effective resistance fails compliance,
modifying the layout diagram to facilitate compliance.

2. The method of claim 1, wherein:
the gate region extends from a first isolation region to a second isolation region through the active region; and
the gate region has a second width across the first isolation region, the active region, and the second isolation region.

3. The method of claim 2, wherein the at least four nodes include:
a gate node at a gate structure of the three-dimensional transistor architecture;
a first non-gate node at the first location of the first gate via;
a second non-gate node at a first edge of the gate region overlapping with the first isolation region; and
a third non-gate node at a second edge of the gate region overlapping with the second isolation region, the second edge being opposite to the first edge.

4. The method of claim 3, wherein the building a gate-resistance compact network includes:
simplifying a precursor to the gate-resistance compact network using delta-star transformation to obtain the gate-resistance compact network.

5. The method of claim 3, wherein:
the gate-resistance compact network is equivalent to a half-edge structure with two non-overlapping triangle meshes sharing a common edge; and
the common edge represents an equivalent resistance between the first non-gate node and the gate node.

6. The method of claim 3, wherein:
the layout diagram includes a second gate via at the first edge or the second edge of the gate region.

7. The method of claim 3, wherein:
the layout diagram includes a second gate via and a third gate via at the first edge and the second edge of the gate region, respectively.

8. The method of claim 1, further comprising:
based on the layout diagram, at least one of:
(A) making one or more photolithographic exposures;
(B) fabricating one or semiconductor devices; or
(C) fabricating at least one component in a layer of a semiconductor integrated circuit.

9. The method of claim 1, wherein the determining compliance includes:
performing a simulation based on the layout diagram.

10. The method of claim 1, wherein the design specification includes a speed of the IC device.

11. The method of claim 1, wherein the modifying the layout diagram includes:
changing the first location of the first gate;
one or more of (i) adding a second gate via at a second location along the first width or at a first edge of the gate region or (ii) adding a third gate via a second edge of the gate region.

12. A system for manufacturing an integrated circuit (IC) device, the system comprising a processor and a non-transitory computer readable storage medium including computer program code for one or more programs, the non-transitory computer readable storage medium, the computer program code and the processor being configured to cause the system at least to perform operations comprising:
receiving an layout diagram of an IC device, the layout diagram including as follows,
a gate region having a first width across a first isolation region, an active region, and a second isolation region,
a first gate via at a first location along a second width across the active region, and
a second gate via at a first edge of the gate region;
building a gate-resistance compact network, which includes at least four nodes of a three-dimensional transistor architecture represented by the layout diagram and at least five equivalent resistances between corresponding ones of the at least four nodes;
determining an effective resistance of the gate region based on the equivalent resistances in the gate-resistance compact network; and
performing a circuit simulation based on the effective resistance.

13. The system of claim 12, wherein the at least four nodes include:
a gate node at a gate structure of the three-dimensional transistor architecture;
a first non-gate node, at the first location of the first gate via;
a second non-gate node, at the first edge of the gate region overlapping with the first isolation region; and
a third non-gate node, at a second edge of the gate region overlapping with the second isolation region, the second edge being opposite to the first edge.

14. The system of claim 13, wherein the computer readable storage medium, the computer program code and the processor are further configured to cause the system at least to do as follows including:
regarding a precursor to the gate-resistance network,
simplifying the precursor using delta-star transformation to obtain the gate-resistance compact network.

15. The system of claim 12, wherein:
the performing a circuit simulation includes:
applying a first input voltage signal to the first gate via to estimate a first effective resistance of the gate region; and
apply the first input voltage signal to the first gate via and the second gate via to estimate a second effective resistance of the gate region; and
the computer readable storage medium, the computer program code and the processor are further configured to cause the system at least to do as follows including:
determining compliance of each of the first effective resistance and the second effective resistance with a design specification.

16. The system of claim 12, wherein:
the layout diagram further includes:
a third gate via at a second edge of the gate region, and
the second edge is opposite to the first edge.

17. The system of claim 16, wherein:
the performing a circuit simulation includes:
applying an input voltage signal to the first gate via, the second gate via, and the third gate via.

18. The system of claim 12, further comprising at least one of:
a masking facility configured to fabricate one or more semiconductor masks based on the layout diagram; or
a fabricating facility configured to fabricate at least one component in a layer of a semiconductor integrated circuit based on the layout diagram.

19. A non-transitory computer-readable medium having stored thereon computer executable instructions representing a method of generating an integrated circuit (IC) layout diagram of an IC device, the computer executable instructions being executable by at least one processor to perform the method including:
receiving the layout diagram of the IC device, the layout diagram including as follows,
a gate region having a first width across an active region, and
a first gate via, at a first location along the first width,
selecting at least four nodes and a gate structure of the IC device;
modeling the gate region using a gate-resistance compact network, including the at least four nodes and at least five equivalent resistances correspondingly between each two ones of the nodes of the at least four nodes; and
determining compliance of the layout diagram with a design specification based on the gate-resistance compact network.

20. The non-transitory computer readable medium of claim 19, wherein:
the gate region extends from a first isolation region to a second isolation region through the active region; and
the gate region has a second width across the first isolation region, the active region, and the second isolation region.
